(19) United States
(12) Patent Application Publication
(10) Pub. No.: US 2003/0211830 A1
(43) Pub. Date: Nov. 13, 2003

(54) Portable terminal device

(75) Inventors: Tsuyoshi Takimoto, Kawasaki (JP); Naoyuki Inoue, Kawasaki (JP); Hideki Takahashi, Kawasaki (JP); Hiroyuki Yoshizawa, Kawasaki (JP); Hidenobu Hitosugi, Kawasaki (JP); Atsushi Ishino, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/434,345

(22) Filed: May 9, 2003

(30) Foreign Application Priority Data
May 10, 2002 (JP) 2002-135798(PAT.)

(51) Int. Cl. H04B 7/00

(52) U.S. Cl. 455/41.2; 455/517

(57) ABSTRACT

The present invention provides a portable terminal device that selects any of a plurality of communication partner devices, accesses the selected communication partner device by radio, and acquires different contents. The portable terminal device includes: a memory in which communication addresses assigned to the plurality of communication partner devices are stored; a radiocommunication unit that selects any of the communication addresses to communicate with a specific communication partner device and that includes a Bluetooth module; and a headphone through which music acquired from the communication partner device is listened to.

### BACKGROUND OF THE INVENTION

1. Field of the Invention

The present invention relates to a portable terminal device capable of accessing a plurality of communication partner devices so as to acquire different contents.

2. Description of the Related Art

In recent years, the features of electronic equipment have been developed along with the advancement of electronics. Moreover, improvements in convenience have been devised along with the increased sophistication of an information society. For example, if a headphone connected to a portable audio player having a compact disk (CD) mounted therein as a sound source is used to listen to stereophonic sound, that a personal computer (PC) is connected to a portable telephone in order to transmit or receive a mail, or that a mouse connected to a personal computer (PC) is handled, then the presence of a connection cord may inconvenience a user or impose limitations on distance. It is a also nuisance to have to connect equipment together.

In efforts to solve the above problems, a wireless network technology has been introduced. For example, a short-distance wireless information communication system enabling communications conforming to the Bluetooth standard has been developed in consideration of the convenience of electronic equipment, and adapted to various types of electronic equipment.

For example, if a headphone is used to listen to stereophonic music, the headphone may be connected to a portable audio player. Otherwise, a method of reproducing music using a personal computer (PC) may be adopted. According to the method, music distributed over the Internet may be reproduced by utilizing a streaming technique. Otherwise, music is downloaded into a hard disk incorporated in a personal computer, reproduced at the personal computer, and then transmitted to the headphone or the like. Instead of downloading music into the hard disk incorporated in the personal computer, music stored in a compact disk (CD) may be copied into the personal computer.

Furthermore, in order to listen to music, music may be reproduced at a personal computer. According to another method, music stored in the hard disk of the personal computer is copied into another recording medium, for example, a removable storage medium such as a compact disk or a mini disk (MD). In this case, the removable storage medium is loaded in a portable audio player or the like in order to listen to music.

As mentioned above, various methods are available in reproducing music so as to listen to the music. However, if a personal computer is used to listen to music being reproduced, as the personal computer is usually kept in one place, a user cannot listen to music while moving.

Moreover, when a portable audio player is used to listen to music, as long as music is reproduced directly from a compact disk, there is no problem. However, when music downloaded into the hard disk of a personal computer is copied into a storage medium, the data representing the music and having a cipher key appended thereto as a means for protecting the copyright of the music must be copied into the storage medium. Therefore, copying the music data is rather time-consuming. Besides, music remaining in the hard disk of the personal computer cannot be reproduced in order to listen to the music.

As a method of listening to music while moving, a method of utilizing an infrared wireless headphone is known. However, this method enables point-to-point communication alone. In order to listen to different pieces of music stored in a plurality of personal computers, an infrared wireless system must be implemented in the respective personal computers. Furthermore, since infrared light waves are utilized as a communication medium, a transmitter and a receiver must be opposed to each other. This poses a problem in that a user cannot listen to music while freely moving about.

An object of the present invention is to provide a portable terminal device capable of acquiring contents preserved in accessed communication partner device. Herein, radiocommunication addresses assigned to a plurality of communication partner devices are registered in the portable terminal device, and the portable terminal device switches and accesses the plurality of communication partner devices located at different places.

### SUMMARY OF THE INVENTION

In order to solve the foregoing problems, the present invention provides a portable terminal device comprising: a radiocommunication unit communicating with a specific communication partner device by selecting any of communication addresses registered in association with a plurality of communication partner devices and thus communicating with the specific communication partner device; an acquiring unit acquiring contents preserved in the communication partner device; and an output unit transmitting the contents acquired by the acquiring unit.

Furthermore, the contents to be acquired by the acquiring unit are contents on which copyright is reserved. Otherwise, the contents to be acquired by the acquiring unit include at least one of music, voice, motion pictures, and still images.

Moreover, an operating unit to be handled to perform various manipulations is included. When the operating unit is handled to perform a manipulation, a communication command associated with the manipulation is produced. The radiocommunication unit transmits the communication command to the communication partner device.

### BRIEF DESCRIPTION OF THE DRAWINGS

These and other objects of the present invention and the features thereof will be clarified from the following description of the preferred embodiments given with reference to the attached drawings, wherein:

FIG. 1 is an explanatory diagram showing the appearance of a portable terminal device in accordance with the present invention;

FIG. 2 is an explanatory diagram showing a concrete example of a screen image displayed on the display screen of the portable terminal device;

FIG. 3A to FIG. 3C are explanatory diagrams showing examples of screen images displayed on the display screen of the portable terminal device;

FIG. 4 is an explanatory diagram showing an example of entering information through a screen image displayed on the display screen of the portable terminal device;

FIG. 5 is a block diagram showing the configuration of a personal computer;

FIG. 6 is a block diagram for explaining storage of music;

FIG. 7 is a block diagram showing the configuration of a portable terminal device; and

FIG. 8 is a flowchart describing a procedure that starts with a step of connecting a headphone to a portable terminal device and ends with a step of listening to music using the headphone.

### DESCRIPTION OF THE PREFERRED EMBODIMENTS

Now, an embodiment of the present invention will be described by taking for instance a case where a headphone connected to a portable terminal device is used to listen to music. Herein, music that is downloaded into a hard disk incorporated in a personal computer in advance and serves as contents having copyright reserved thereon is reproduced by the personal computer that is remotely controlled using the portable terminal device.

As one form of a system enabling provision of contents, a system in which a portable terminal device and a plurality of personal computers each have a module conformable to the Bluetooth standard that stipulates short-distance radiocommunication and can bi-directionally communicate with one another will be taken for instance. According to the present embodiment, communication addresses with which a plurality of communication partner devices, that is, the plurality of personal computers is identified are registered in the portable terminal. The portable terminal device switches the communication addresses so as to select any of pieces of music, that is, contents having copyright reserved thereof and being by the personal computers, and then acquires selected music according to a streaming technique.

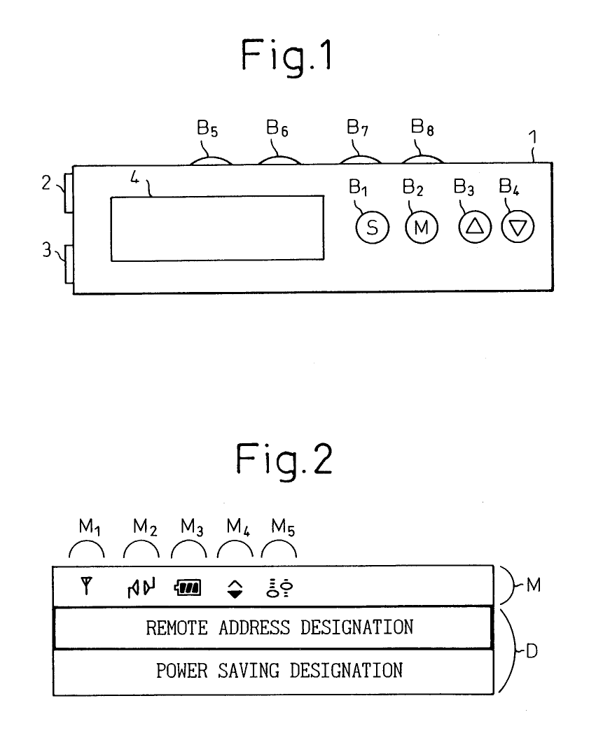

FIG. 1 shows the appearance of a portable terminal device. The portable terminal device 1 includes all components required for a portable terminal device, such as, a Bluetooth module, a Bluetooth antenna, a music reproduction circuit, and a power supply, though these components are not shown. The portable terminal device 1 has a headphone jack 2 and a jack 3 for speech receiver-transmitters including a telephone.

Furthermore, the portable terminal device 1 has a display screen 4 and a plurality of operation buttons B1 to B8. The display screen 4 is used to display the operating state of the portable terminal device and various settings thereof. The operation button B1 is used to switch a speech mode in which the portable terminal device acts as a telephone and an audio mode. The operation button B2 is used to switch menus displayed on the display screen 4. The operation buttons B3 and B4 are used to adjust a volume. The operation button B3 is pressed in order to increase the volume, while the operation button B4 is pressed in order to decrease the volume. The operation button B5 serves as a Back button to be used to return control to a previous step of a procedure. The operation button B6 serves as a Stop button. The operation button B7 serves as a Play/Pause button. The operation button B8 serves as a Next button to be used to advance control to a succeeding step of the procedure.

Now, referring to FIG. 2 to FIG. 4, how to use the operation buttons and how to enter a communication address assigned to a personal computer using the portable terminal device 1 will be described below.

FIG. 2 shows an example of information displayed on the display screen 4. The display screen 4 is divided into an operating state display area M and an information display area D. Marks M1 to M5 indicating an operating state of the portable terminal device are displayed in the operating state display area M. As long as the power supply of the portable terminal device is on, the marks are always displayed in the display area M.

The mark Ml indicates the receiving state of the antenna incorporated in the portable terminal device. For example, when the receiving state is satisfactory, a larger number of vertical lines appears. The mark M2 indicates the state of communicational connection with a personal computer that is a selected communication partner device. In the drawing, a state of no connection is indicated. The mark M3 indicates the state of the power supply of the portable terminal device. In the drawing, a fully-charged state is indicated. The mark M4 indicates that a plurality of information items should be displayed in the information display area D. An upside-down black triangle indicates that there is another information aside from information currently displayed in the information display area D. Moreover, the mark M5 indicates a mode selected using the operation button B1. When a headphone is used to listen to music, a clef mark appears.

On the other hand, two items are displayed in the information display area D on the display screen 4. In FIG. 2, two items can be displayed. The number of information items that can be displayed on the display screen 4 depends on a font and the size of a main body 1, and may be larger than 2. As for information to be displayed in the information display area D, for example, when music is being listened to, the title of the music is displayed. When the menu switching button B2 is pressed in order to determine the settings of the portable terminal device, menu names Remote Address Designation, Power Saving Designation, Wakeup Designation, Operational Sound Designation, and Local Address Display are displayed. Referring to FIG. 2, the two menu names Remote Address Designation and Power Saving Designation are displayed.

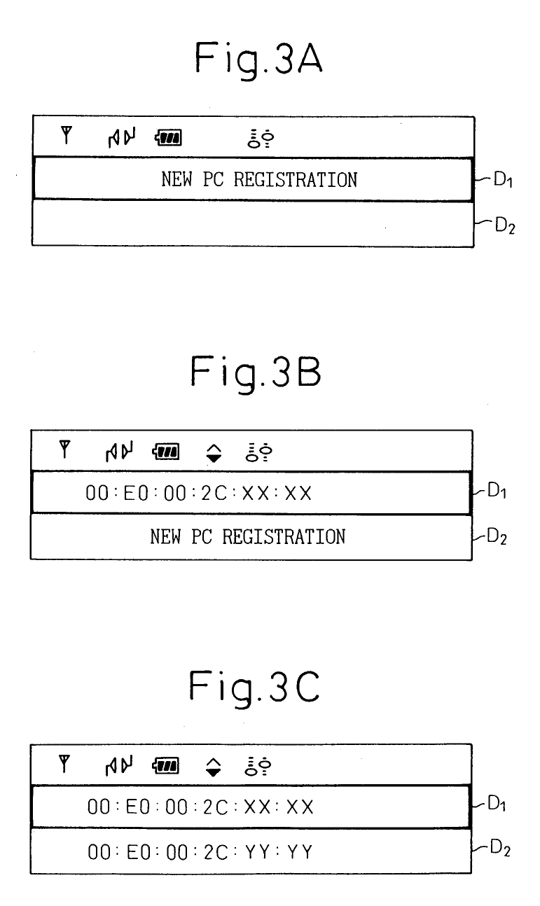

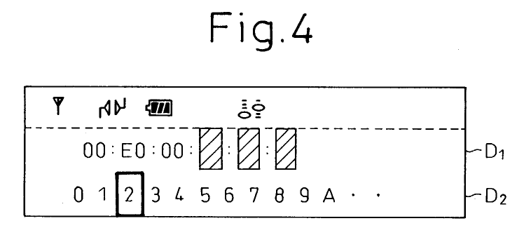

Referring to FIG. 3A to FIG. 3C and FIG. 4, a description will be made of a case where Bluetooth communication addresses to be assigned to a plurality of personal computers are determined using the display screen 4 of the portable terminal device. First, as shown in FIG. 2, the Next button B8 or Back button B5 is pressed in order to move a cursor. The Play/Pause button B7 is then pressed with the cursor located on Remote Address Designation. In the drawing, for brevity's sake, the cursor is shown as a boldfaced frame. Alternatively, the cursor may take the form of highlighting. If the display screen 4 can display colors, the cursor may be realized with highlighting in a different color.

When Remote Address Designation is selected, for example, New PC Registration is, as shown in FIG. 3A, displayed in an information display area D1. Assume that the communication addresses assigned to a plurality of personal computers have not yet been registered but are newly registered at the delivery of a product or on any other occasion. In this case, New PC Registration is displayed in the information display area D1, and an information display area D2 is left blank.

If only one communication address of a personal computer has been registered, the registered communication address such as 00:E0:00:2C:XX:XX is displayed in the information display area D1. New PC Registration is, as shown in FIG. 3B, displayed in the information display area D2.

If the communication addresses assigned to a plurality of personal computers have already been registered, the communication addresses such as 00:E0:00:2C:XX:XX and 00: E0:00:2C:YY:YY are displayed in the information display areas D1 and D2 respectively.

Once the Bluetooth communication addresses are selected, the personal computers that are communication partner devices become accessible. The six leading characters of 00:E0:00:2C:XX:XX serve as a vendor identification code assigned to the portable terminal device, and the six succeeding characters thereof serve as an identification code assigned to a communication partner device. The two characters of 2C indicate a type of device that is a personal computer. For example, if a communication partner device is an audio player, 2A is displayed. The four characters of XX:XX are unique to the personal computer. Referring to FIG. 3C, YY:YY is assigned to another personal computer different from the personal computer.

In order to newly register a communication address of a personal computer, the cursor is moved onto New PC Registration and the Play/Pause button B7 is pressed. Consequently, an entry screen image permitting a user to enter a communication address is displayed in the information display area D. In order to register a communication address of other personal computer so that the personal computer can be accessed, a communication address of a personal computer that has already been registered may be deleted or modified. In this case, the cursor is moved onto the communication address of the personal computer that will be modified, and the Play/Pause button B7 is pressed. This causes the entry screen image to appear.

An address entry field is displayed as part of the entry screen image in the information display area D1, and a character string helping a user enter an address is displayed as part of the address entry field in the information display area D2. The six leading characters of an address serve as a vendor identification code assigned to a portable terminal device, and are therefore displayed on a fixed basis. Entry boxes are presented for the six trailing characters. In the drawing, hatched rectangles are shown as the entry boxes.

A character string to be entered in the entry boxes consists of numerals and alphabets required to determine a Bluetooth communication address. For example, characters of 0 to 9 and A to F are employed. The characters that can be employed are displayed in the information display area D2. A cursor of a boldfaced rectangular frame is displayed so that characters can be selected one by one. The Next button B8 or Back button B5 is manipulated in order to move the cursor to an intended character. When the Play/Pause button B7 is pressed, the character is entered. Referring to FIG. 4, 2 of 2C is about to be entered. The cursor is thus moved over the characters in order to enter six characters one by one.

As mentioned above, the portable terminal device of the present embodiment has the feature permitting registration of a plurality of Bluetooth communication addresses assigned to a plurality of personal computers, that is, communication partner devices accessible according to the Bluetooth standard. Owing to the feature, the buttons and display screen of the portable terminal device are used to register a communication address unique to a personal computer that is a communication partner device. The personal computer thus becomes accessible. A communications protocol on which the portable terminal device and the personal computer agree on is determined in advance. Consequently, music having copyright reserved thereon and being reproduced by the personal computer can be listened to using the portable terminal device. When a Bluetooth communication address of other personal computer is determined by handling the portable terminal device, the personal computer also becomes accessible. For example, music having copyright reserved thereof and belonging to a different category can be listened to.

The communications protocol should be the one stipulated by the Bluetooth standard. For compression or decompression of music data, MP3 that is one of sound compression techniques stipulated by the MPEG motion picture standard may be adopted. Otherwise, an existing method such as the adaptive transform acoustic coding (ATRAC) system may be adopted. According to the ATRAC system, a signal is compressed in both the time domain and frequency domain by utilizing the auditory characteristics of human beings.

A description has been made by taking for instance music, which has copyright reserved thereon and is transmitted according to a streaming technique, as contents capable of being processed by the portable terminal device. As the portable terminal device has, as shown in FIG. 1, the speech transmitter receiver jack, the portable terminal device can communicate voice. Moreover, if the display screen 4 is designed as a large-size color screen, data representing a motion picture or a still image and being transmitted in the form of a data stream according to the streaming technique can be dealt with. A communications protocol permitting transmission of the data stream is implemented in the portable terminal device so that the data stream can be reproduced. Moreover, the communication partner device is not limited to a personal computer but may be electronic equipment in which a communication system including Bluetooth facilities is installed, for example, an audio player, a navigation system, and a DVD.

Normally, data representing voice, music, or a motion picture requires a larger storage capacity than data representing a text or a still image does. When a method of receiving all data first and thereafter transferring it is adopted, the wait time required until the data is transferred is too long and the cost of a portable terminal device itself is too high. Consequently, preferably, data is received in the form of a data stream and transferred successively.

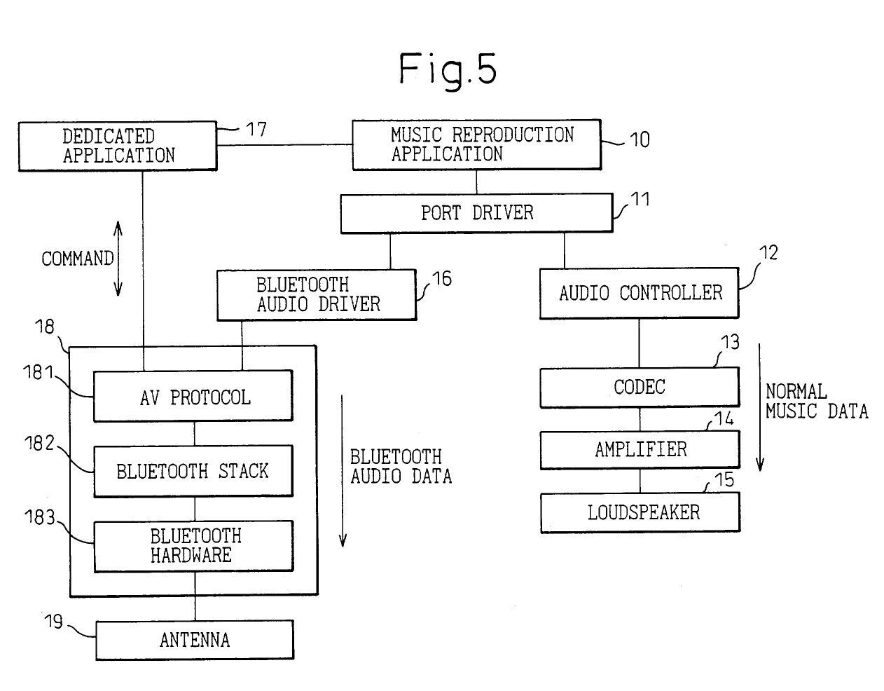

FIG. 5 is a block diagram showing a communication partner device capable of transmitting music data to a portable terminal device including a Bluetooth interface.

A personal computer that is a communication partner device has features for reproducing music, which serves as contents, which has copyright reserved thereon and is downloaded into the hard disk of the personal computer, within the personal computer. A music reproduction application 10 for reading music data from the hard disk, reproducing music, and creating a reproduction list is installed in the personal computer. The reproduced music is distributed from a loudspeaker 15 via an audio controller 12, a codec 13 such as model AC'97, and an output amplifier 14. A headphone may be substituted for the loudspeaker 15, whereby voice can be distributed.

On the other hand, as features for transmitting music data to a portable terminal device using a communication system conformable to the Bluetooth standard, an AV protocol 181 is implemented in a personal computer, a Bluetooth stack 182 is defined therein, and Bluetooth hardware 183 are included therein. Moreover, a Bluetooth module 18 to which an antenna 19 is connected is included in the personal computer. The bluetooth module 18 having conventional components can be used as it is.

A dedicated application 17 for controlling the Bluetooth module 18 is installed in the personal computer. Commands to be sent from a portable terminal device serving as a remote controller are analyzed in order to instruct the music reproduction application 10 to reproduce music. Moreover, the dedicated application 17 receives the title of the music from the music reproduction application 10 and transfers it to the Bluetooth module 18. Thus, the title of music being reproduced is displayed on the display screen 4 of the portable terminal device.

The music reproduction application 10 reproduces designated music in the form of a data stream in response to a reproduction instruction issued from the dedicated application 17. The music is transferred to the Bluetooth module 18 via a port driver 11 and a Bluetooth audio driver 16. The music is then transmitted in the form of a data stream to the portable terminal device, which has requested the music, according to a communication method conformable to the Bluetooth standard.

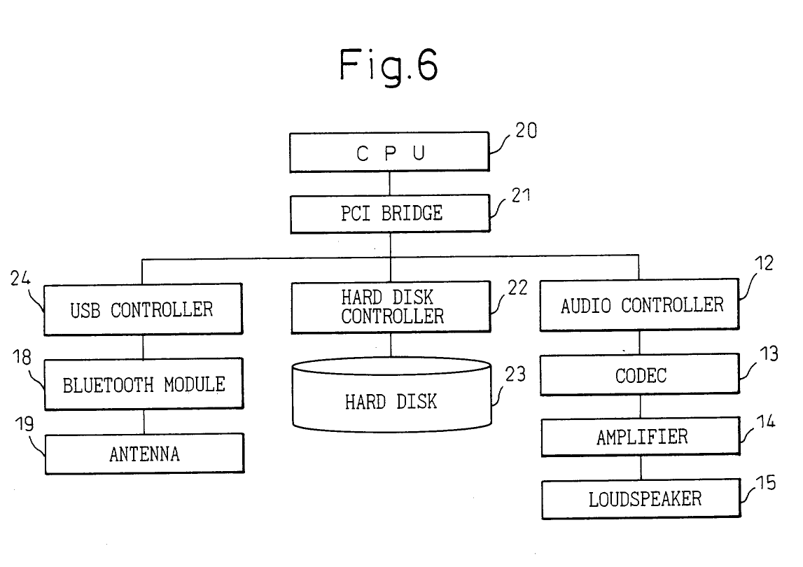

FIG. 6 is a block diagram showing the flow of music within a personal computer shown in FIG. 5. In FIG. 6, the same reference numerals are assigned to the same components identical to those shown in FIG. 5.

A CPU 20 included in the personal computer performs various arithmetic operations. In particular, for music reproduction concerned with the present embodiment, the CPU 20 manages the audio controller 12, a hard disk 22, and a USB controller 24 which are connected to the CPU 20 over a PCI bus realized with a PCI bridge 21. Moreover, the CPU 20 runs the music reproduction application 10 and dedicated application 17 shown in FIG. 5.

In order to execute normal music reproduction in the personal computer, the music reproduction application 10 must be run. Music designated using the operating panel of the personal computer is read from among pieces of music that serve as contents having copyright reserved thereon and that are downloaded from the hard disk 23 connected to the hard disk controller 22. The read music is transferred to the audio controller 12, and distributed from the loudspeaker 15 via the codec 13 and amplifier 14.

By the way, Bluetooth communication addresses are registered in the personal computer. When the portable terminal device serving as a remote controller is handled in order to transmit a selected address, if the address is the address assigned to the personal computer, the dedicated application 17 is activated via the Bluetooth module 18 and USB controller 24.

The dedicated application 17 issues a music reproduction instruction to the music reproduction application 10. Music is then read from the hard disk 23, and transferred in the form of a data stream to the Bluetooth module 18 via the hard disk drive 22 and USB controller 24 according to a streaming technique. The music is transmitted to the portable terminal device through the antenna 19 according to a communication method conforming to the Bluetooth standard.

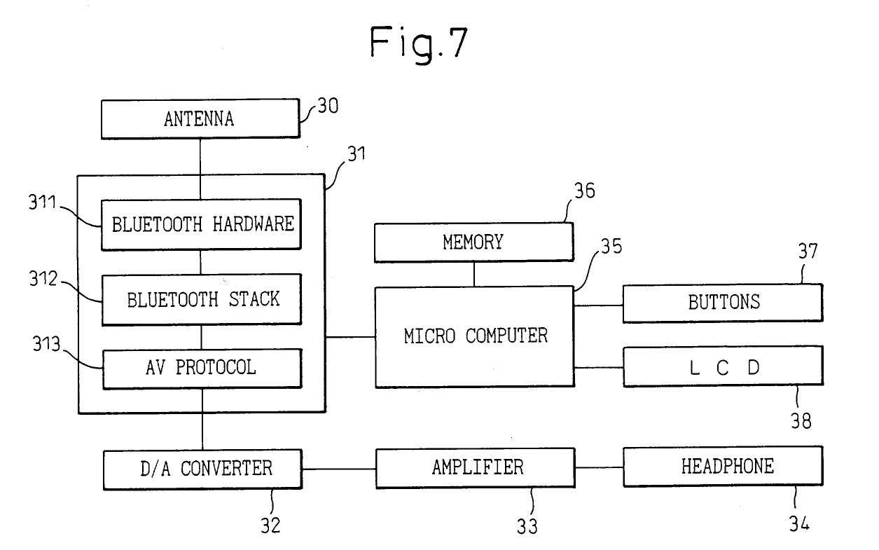

FIG. 7 is a block diagram showing the portable terminal device serving as a remote controller. The portable terminal device includes a Bluetooth module 31. The Bluetooth module 31 has the same components as the Bluetooth module 18 included in the personal computer. Namely, Bluetooth hardware 311 is included in the portable terminal device, a Bluetooth stack 312 is defined therein, and an AV protocol 313 is implemented therein. The music received through the antenna 30 is processed by the Bluetooth module 31 and a D/A converter 32, and then distributed from a headphone 34 via an amplifier 33.

Furthermore, the portable terminal device includes a microcomputer 35, a memory 36, buttons 37, and an LCD 38 which are required in order to execute activities including those involving the Bluetooth features. The microcomputer 35 is connected to the Bluetooth module 31 via asynchronous serial interfaces conformable to the RS232C or UART standard. The microcomputer 35 produces a command, controls entry of settings, or controls display of information responsively to a manipulation performed on any of the buttons 37 including the operation buttons B1 to B8 shown in FIG. 1.

Programs required to operate the microcomputer 35 are stored in the memory 36. A small-capacity flash memory is also included. Addresses assigned to Bluetooth modules included in a plurality of communication partner devices, which are characteristic of the present embodiment, are stored in the flash memory. The LCD 38 is a display section of the portable terminal device. Normally, a liquid crystal display is adopted and has a screen corresponding to the display screen 4 shown in FIG. 1.

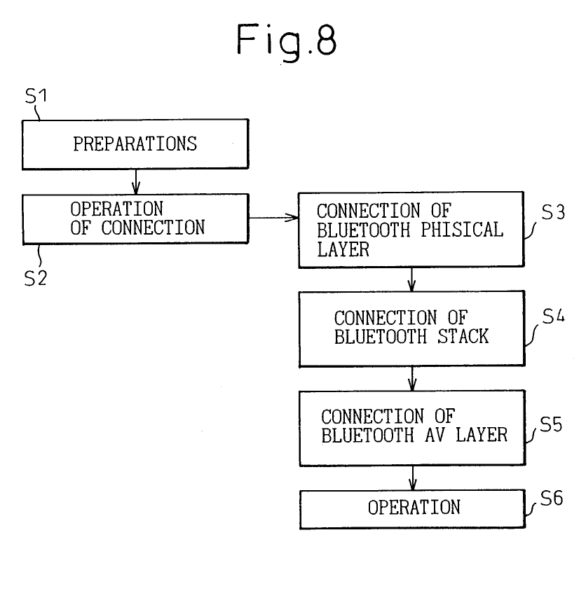

A personal computer and a portable terminal device that have Bluetooth features as mentioned above are used to utilize contents having copyright reserved thereon. A procedure of listening to music, which is contents having copyright reserved thereon and is downloaded into a plurality of personal computers, using the headphone of the portable terminal device will be described with reference to FIG. 8 below.

First, preparations are made for bi-directional communication between a personal computer that is a communication partner device and a portable terminal device that serves as a remove controller (step S1). A user manipulates the operation buttons of the portable terminal device so as to store communication addresses, which are assigned to personal computers in advance, in the flash memory according to the aforesaid procedure of registering remote addresses. Moreover, the user activates the music reproduction application installed in each of the personal computers so as to create a reproduction list, which lists pieces of music which the user wants to listen to out of all the pieces of music downloaded into each personal computer, for each personal computer.

When preparations for music reproduction have been made, the user uses the portable terminal device, which is located away from the personal computers, to connect the portable terminal device to a certain personal computer (step S2). First, the button B1 of the portable terminal device is pressed in order to designate the audio mode. When the audio mode is designated, the registered communication addresses assigned to the plurality of personal computers are, as shown in FIG. 3C, displayed on the display screen 4. The user then manipulates the operation buttons so as to select any of the displayed communication addresses, and thus designates a personal computer capable of reproducing the user-desired music. At this time, when the Play button B7 is pressed, the personal computer of the communication address is accessed.

In the accessed personal computer, a music reproduction instruction is issued to the music reproduction application along with the access. Consequently, a music data stream is transmitted to the portable terminal device via the Bluetooth module 18 according to the reproduction list with the title of music displayed on the portable terminal device.

In the portable terminal device, the Bluetooth module 31 passes received data through a Bluetooth physical layer (step S3), a Bluetooth stack (step S4), and a Bluetooth AV layer (step S5) respectively. Consequently, the music is, as shown in FIG. 7, transferred to the headphone 34 via the D/A converter 32 and amplifier 33. The user can now listen to the pieces of music, which are downloaded into the designated personal computer, in order of the pieces of music being listed in the registered production list.

The portable terminal device has, as shown in FIG. 7, various operation buttons. When any operation button is pressed, an associated command is produced and communicated according to the Bluetooth standard. Thus, an instruction indicating that manipulations should be performed for reproduction can be issued to the communication partner device (step S6). The portable terminal device does not have the ability to reproduce received music data. Manipulations to be performed in order to reproduce music cause the music reproduction application installed in the personal computer to act accordingly.

For example, by pressing the Play-Pause button B7, reproduction of music or stop thereof can be instructed. By pressing the Next button B8 or Back button B5, reproduction of pieces of music listed in the reproduction list registered in the personal computer can be advanced or returned in units of a piece of music. Since music downloaded into a personal computer is reproduced as it normally is, manipulations can be performed in the same manner as they are when music is listened to through the loudspeaker 15 connected to or incorporated in the personal computer.

In a case where music is listened to using a portable terminal device, a personal computer switches modes for fear sound may be distributed from the loudspeaker 15 connected to or incorporated in the personal computer.

As mentioned above, according to the present embodiment, a communicating unit conforming to the Bluetooth standard is incorporated in a portable terminal device serving as a remote controller and in a plurality of personal computers that are communication partner devices. Bluetooth communications addresses assigned to the plurality of personal computers are registered in the portable terminal device. The remote controller is used to select any of the Bluetooth communications addresses. Consequently, the portable terminal device is connected to the selected personal computer through short-distance radiocommunication.

As the portable terminal device is connected to the selected personal computer through short-distance radiocommunication, music that is contents having copyright reserved thereon and downloaded into the personal computer can be reproduced by the personal computer and listened to through a loudspeaker connected to or incorporated in the personal computer. Moreover, the music can be listened to through a headphone connected to the portable terminal device.

A description has been made on the assumption that music is preserved. Contents having copyright reserved thereon and being preserved in a personal computer are not limited to music but may be motion pictures or still images. However, when the contents are motion pictures or still images, the LCD 38 of the portable terminal device must be able to display images, and the microcomputer 35 must be programmed to be able to process display image data.

Moreover, a description has been made on the assumption that communication partner devices are personal computers. A contents utilization system in accordance with the present embodiment can be adapted to electronic equipment in which a communicating unit conforming to the Bluetooth standard is incorporated and in which contents capable of being transmitted in the form of a data stream are preserved. For example, an audio player, a navigation system, and a DVD can be adopted as the plurality of communication partner devices.

As described so far, according to the present invention, a technology enabling registration of a plurality of communication addresses in a portable terminal device to be used is employed so that the sole portable terminal device serving as a remote controller can communicate with a plurality of communication partners by radio. Consequently, pieces of music downloaded into a plurality of personal computers can be acquired readily. A user can listen to the music in a place away from the personal computers while acting freely.

Contents include voice, motion pictures, and still images which have copyright reserved thereon. Communication addresses which are assigned to a plurality of personal computers having the contents preserved therein and with which the personal computers can be accessed are registered in the portable terminal device. Consequently, a user can acquire required contents in a remote place while moving. Moreover, copyright will never be infringed on.

The invention has been described with reference to specific embodiments chosen for the purpose of illustration. It is apparent that those skilled in the art can make numerous modifications on the invention without departing from the basic concept and scope of the invention.

The present disclosure relates to a subject matter contained in Japanese Patent Application No. 2002-135798 filed on May 10, 2002, the disclosure of which is expressly incorporated herein, in its entirety, by reference.

What is claimed is:

1. A portable terminal device comprising:
a radiocommunication unit selecting any of communication addresses registered in association with a plurality of communication partner devices so as to communicate with a specific communication partner device;
an acquiring unit acquiring contents from the communication partner device; and
an output unit transmitting the contents acquired by said acquiring unit.

2. A portable terminal device according to claim 1, wherein the contents to be acquired by said acquiring unit are contents having copyright reserved thereon.

3. A portable terminal device according to claim 1, wherein said output unit includes a display screen and a loudspeaker or a headphone.

4. A portable terminal device according to claim 1, wherein the contents to be acquired by said acquiring unit include at least one of music, voice, motion pictures, and still images.

5. A portable terminal device according to claim 1, wherein the contents are represented by data downloaded into the hard disks of personal computers.

6. A portable terminal device according to claim 1, further comprising an operating unit that is handled to perform various manipulations, wherein:
when said operating unit is handled in order to perform a manipulation, a communication command associated with the manipulation is produced; and
said radiocommunication unit transmits the communication command to the communication partner device.

7. A portable terminal device according to claim 6, wherein said acquiring unit acquires a data stream, which is designated with the communication command, from data representing the contents.

8. A portable terminal device according to claim 7, wherein the communication command includes an instruction to acquire a data stream from the data representing the contents or an instruction to stop acquisition.
